(19) United States
(12) Patent Application Publication
(10) Pub. No.: US 2013/0325630 A1
(43) Pub. Date: Dec. 5, 2013

(54) Systems and Methods for Providing Personalized Content Browsing Experience

(71) Applicant: Archetypes, Inc., New York, NY (US)

(72) Inventors: Michael Mendenhall, New York, NY (US); Karl Walsh, New York, NY (US)

(21) Appl. No.: 13/908,325

(22) Filed: Jun. 3, 2013

Related U.S. Application Data
(60) Provisional application No. 61/654,411, filed on Jun. 1, 2012.

(51) Int. Cl. G06Q 30/02

(52) U.S. Cl. CPC G06Q 30/0269
USPC 705/14.66

(57) ABSTRACT

A method, a system, and a computer program product for providing personalized content browsing experience are provided. An archetype of a user is determined. The archetype is associated with at least one attribute. Content is filtered based on at least one attribute associated with the determined archetype and at least one descriptor associated with the content. The filtered content is provided to the user.

### CROSS-REFERENCE TO RELATED APPLICATIONS

The present application claims priority to U.S. Provisional Patent Application No. 61/654,411 to Sun at al., filed Jun. 1, 2012, and entitled “Providing Personalized Content Experiences,” and incorporates its disclosure herein by reference in its entirety.

### TECHNICAL FIELD

The present application relates generally to data processing and in particular, to providing personalized content to users based on archetypes.

### BACKGROUND

Providers of content often attempt to personalize a user's content experience. For example, online retailers attempt to increase sales by presenting products for potential purchase that can be more relevant to a user than other products. Often, such personalization can be based on information gathered during previous user content browsing sessions, such as data gathered regarding previous products that a user has purchased, as well as basic information gathered about the user and user's browsing activities, data provided by the user, data provided by other user, and/or any other data.

However, personalizing a content browsing experience, such as shopping, using previous browsing data, often does not result in presentation of content that is relevant for a user. For example, if a user has purchased a television in the past, using previous shopping purchase data might result in presentation of other televisions for potential purchase. Since the user has already purchased a television, the user might not want another and such content might not be relevant for the user. Even presenting products that can be utilized along with such a television might not be relevant to the user as the user might not be the sort of person who would consider using such related products with the television. Additionally, prior purchase (or search, etc.) for a television does not provide any information as to why the user maybe visiting a certain website. Thus, previous browsing data might not yield any more relevant content for a user than content chosen at random.

Oftentimes, users browsing for content can wish to be provided with content that can be tailored to specific user personalities, lifestyles, preferences, desires, traits, hobbies, etc. Conventional browsing systems lack the ability to present users with such level of personalized content browsing, the ability to look for content that is specifically interesting to them, and thus, the users can be left without guidance as to how to find content that can be suitable to them.

### SUMMARY

In some implementations, the current subject matter relates to a computer implemented method for providing a personalized content browsing experience. The method can include determining an archetype of a user, wherein at least one attribute is associated with the determined archetype, filtering a content based on at least one attribute associated with the determined archetype and at least one descriptor associated with the content, and providing the filtered content to the user. At least one of the determining, the filtering, and the providing can be performed by at least one processor.

In some implementations, the current subject matter can include one or more of the following optional features. The determining can include selecting, by the user, the determined archetype from a plurality of archetypes. The determining can also include providing at least one question to the user, receiving a response to the provided at least one question from the user, and assigning, based on the received response, the determined archetype from a plurality of archetypes to the user.

In some implementations, the method can include associating at least one descriptor with the content, wherein at least one descriptor identifies content.

In some implementations, filtering can include comparing at least one attribute of the determined archetype with at least one descriptor of the content and determining, based on the comparing, whether at least one attribute of the determined archetype matches at least one descriptor of the content. In some implementations, providing can include providing the filtered content to the user based on the determination that at least one attribute of the determined archetype matches at least one descriptor of the content. In some implementations, filtering can include filtering the content based on a previous content provided to the user. The archetype filtering can provide qualitative and user controlled layers above traditional personalization mechanisms. In some implementations, the system can allow the user to select a “life passage,” a descriptor for the phase of life they are in. This can allow personalization not just based on a personality type and past behavior but also with the depth the current events of a person's life. For example, a caregiver who can have regularly purchased and engaged with travel may be responsive to very different content after having a baby such as going from adventure travel to family friendly travel. Moreover, they may not be as engaged with travel as they are with advice on parenting.

In some implementations, the method can further include determining another archetype of the user and ranking the determined archetype and another determined archetype. At least another attribute can be associated with another determined archetype. The providing can include providing the filtered content in a ranking order based on the ranking of the determined archetype and another determined archetype.

In some implementations, the method can also include receiving a request to modify the determined archetype assigned to the user and modifying, based on the receiving, the determined archetype assigned to the user.

In some implementations, the method can also include re-filtering the filtered content based on at least one archetype that is different from the determined archetype and providing the re-filtered content to the user.

In some implementations, the method can also include sorting the filtered content based on at least one criteria and providing the sorted content to the user.

In some implementations, the method can also include identifying a group of first contents having at least one relationship to each other, determining a second content related to the group of first contents, and providing the second content to the user. The method can also include modifying the identified group of first contents by modifying at least one first content in the identified group of first contents, determining a third content based on the modified group of first contents, and providing the third content to the user. The group of first contents can be identified based on the determined archetype of the user.

In some implementations, the current subject matter relates to systems, methods, and computer program products for providing personalized content experience to users. A user can be provided with a plurality of questions relating to a user's personality, preferences, lifestyle, and so on. The user's responses to the personality questions can be received. The user can be assigned to one or more “archetypes,” or personality models, based on the user's responses. In some cases, users can be able to select one or more archetypes for themselves directly as opposed to answering questions (and/or can be able to pick one or more archetypes instead of the one or more archetypes that have been assigned based on answers to questions). Content that can be presented to the user can be tagged with various descriptors, such as various adjectives or attributes, that are associated with one or more of the archetypes.

In some implementations, when content is presented to the user the content can be filtered based on the archetype or archetypes and the tags. The filtered content can then be presented to the user.

Users can benefit in a number of ways from being provided such personalized content experiences. As a user's content browsing experience is filtered according to the user's personality, preferences, lifestyle, and so on, the user can be able to find relevant content easier without having to search through the entire vast amount of content that is available. Further, because the user's content browsing experience is so tailored to the user's personality, preferences, lifestyle, and so on, content browsing can itself be an entertainment and/or lifestyle activity as opposed to an annoying and boring process that must be performed in order to find content. In at least these ways, providing such personalized content experiences can enhance content browsing for users. Users can explore, locate and view other archetype(s) and/or archetype(s) of other users and content that can be associated with the archetype(s) and/or content that can be associated with a particular user's archetype(s). For example, the user can access other user's “boards” (e.g., other user's personalized websites that can display information about the other user and the content that has been delivered to the user and/or content that the other user found interesting) and view content that the other user has browsed for and/or content that may have been presented to the other user based on the other user's archetype(s), prior browsing experience of the other user, content provided to the other user by third parties (e.g., other users), etc. The user can also view the other user's content that can be specific to the other user's archetype (e.g., the user wishes to view content that can be associated with the other user's “rebel” archetype). In some implementations, users can also offer and/or provide content to other users by sending an indication to other users that content can be of interest to the other users based on users' beliefs, knowledge, etc. of other users' archetypes, interests, hobbies, preferences, etc. Once the other users indicate that the content provided to them is of interest, their browsing experience can be further tailored based on the content provided (e.g., a user having a “caregiver” archetype can indicate that content provided to them by another user or otherwise found and viewed by the user, e.g., content related to “rebel” archetype, is of interest to the user, prompting tailoring of the content delivery to the user to include “rebel” archetype related content).

In some implementations, content can be tagged with descriptors, adjectives, and/or attributes associated with one or more archetypes by one or more experts who, optionally using proprietary consumer research, evaluate content and assign descriptors based on such evaluation. In some implementations, content can be similarly tagged by users as part of their browsing experience. In some implementations, content can be tagged indirectly by the browsing experiences of users by the content being tagged in response how users who are assigned to one or more archetypes interact with the content.

In some implementations, in addition to curating by experts and/or third parties, the current subject matter can automatically archetype item(s) based on item(s) attributes and how they map to different archetypes. This attribute mapping can constantly evolve as trends change and more information is learned about the user. A variety of technology tools can be used to extract attributes from content (e.g., universal resource locator (“URL”), metatags, key words, etc.).

In some implementations, content can be presented to the user in various other ways related or unrelated to the archetype or archetypes assigned to the user.

In some implementations, users can be able to browse content (such as products or other items available for purchase) in groups (such as outfits). In such cases, the items can be tagged with attributes and/or other descriptors describing their relationship to other products that can be part of a group as well as descriptors associated with archetypes. For example, a user can be able to shop for an entire outfit that can be initially presented based on one or more archetypes assigned to the user and/or any other archetype that can be selected by the user and/or viewed by the user and associated with one or more descriptors tagged to the items in the outfit. The items can also be tagged with descriptors describing what other items they can be matched with and/or other characteristics of the items. As such, various items of the outfit can be locked by the user (indicating that the user wishes to purchase that portion of the outfit) whereas other items can be swapped by the user for other items of a similar type (which might not necessarily be tagged with descriptors associated with one or more archetypes assigned to the user).

In some implementations, the personalized content experience can include social networking services provided to users based on archetypes. Such a social networking can enable users to communicate with each other (such as via messaging, “friending” other users, engaging in chat sessions with other users, sharing purchase histories with other users, sharing wish lists with other users, browsing through content together with other users, sharing information regarding archetypes assigned to a user with other users, guessing other users archetypes, answering personality questions about other users to modify archetypes assigned to those users, creating content to share with other users, and so on). The social networking site can enable communication between users regardless of the archetypes assigned to the various users. The social networking site can also provide users the ability to interact with other users who have been assigned one or more archetypes and understand how they see the world through archetypes.

Computer program products are also described that comprise non-transitory computer readable media storing instructions, which when executed one or more data processor of one or more computing systems, causes at least one data processor to perform operations herein. Similarly, computer systems are also described that can include one or more data processors and a memory coupled to the one or more data processors. The memory can temporarily or permanently store instructions that cause at least one processor to perform one or more of the operations described herein. In addition, methods can be implemented by one or more data processors either within a single computing system or distributed among two or more computing systems.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an exemplary block diagram illustrating a system for providing personalized content experience to users based on archetypes, according to some implementations of the current subject matter;

FIG. 2 is a flowchart illustrating an exemplary method for providing personalized content experience to users based on archetypes, according to some implementations of the current subject matter;

FIG. 3 illustrates an exemplary presented personality question, according to some implementations of the current subject matter;

FIG. 4 illustrates an exemplary interface presenting results of a user's responses to the personality questions, according to some implementations of the current subject matter;

FIG. 5 illustrates an exemplary user interface showing a purchasing website for allowing a user to search/select for an item, according to some implementations of the current subject matter;

FIG. 6 illustrates an exemplary user interface showing a purchasing website interface for allowing a user to search/select for a combination of items, according to some implementations of the current subject matter; and

FIG. 7 illustrates an exemplary method, according to some implementations of the current subject matter.

### DETAILED DESCRIPTION

The following description includes sample systems, methods, and computer program products that embody various elements of the present disclosure. However, it should be understood that the described disclosure can be practiced in a variety of forms in addition to those described herein.

In some implementations, the current subject matter relates to providing a personalized content browsing to a user based on user's archetype(s), which can be provided by the user or determined for the user. Archetypes can be personality models that can be used to predict user preferences, behavior, lifestyle, etc. The archetype can provide a qualitative level for the purposes of content search, analysis and/or presentation above conventional personalization models. Each archetype can be associated with at least one attribute that can identify a specific aspect or information of the archetype (for example, a caregiver archetype can have an attribute of “care”). Using the provided archetype, the content can be filtered using filtering mechanisms, which can determine whether an attribute or a descriptor associated with the content matches an attribute of the user's archetype(s). Once the content is filtered, it can be presented to the user on a user interface.

In some implementations, the user's archetype(s) can be determined based on user's answers to various questions that can relate to user's personality, hobbies, preferences, interests, desires, experiences, etc. The questions can be part of a model for determining an archetype and further, can be general and/or specifically tailored to the user and/or can depend on user's answers to other questions. In some implementations, the user can select an archetype and/or a plurality of archetypes from a plurality of available archetypes. The user can select an archetype in addition to and/or instead of the archetype(s) that have been determined based on user's answers to questions. In some implementations, the user can change archetype(s) (whether or not determined based on questions and/or previously selected by the user). Alternatively, content presentation can be changed based user's content browsing experiences (e.g., content searches, content selections, content recommendations, and/or any other actions). In some implementations, the users can be polled and/or surveyed (e.g., by asking the users to answer various questions) about content delivery and/or their archetypes. Subsequent to the polling/surveys, content delivery to the user can be further tailored based on the users' answers. In some implementations, the user can explore and view information and/or content that are associated with an archetype (without selection and/or assignment of the archetype to the user) and make a determination whether or not the viewed archetype can be selected as one of user's archetypes. The user can also view/explore other users' archetypes and/or content that has been presented to and/or obtained by other users (whether or not related to other users' archetype(s)), and based on such exploration/viewing, the content that can be presented to the user can further tailored to include content that can be related to other users' archetypes and/or content. Additionally, users can recommend and/or send content to other users, which can cause further tailoring of content that can be delivered to the other users (which can be dependent upon other users' acceptance of the recommended/sent content). The above determination and/or selection of user archetype(s) can be performed through a user interface that can be associated with at least one processor and/or a memory.

Archetypes are universal patterns of behaviors that, once discovered, help people better understand themselves and others. The concept of archetypes originated from the ancient philosopher Plato and was deepened by Carl Jung, who shed light on personalities and literature by introducing psychological archetypes. Jung also applied this concept as a powerful treatment for those in transition. Over the decades, hundreds of archetypes have been uncovered—the Child, the Great Mother, the Scarecrow, the Trickster, and the Wise Old Man. All are rooted in the idea that while people can play different roles in life, people each ultimately have an essence that defines who they are at the core, who they aspire to be, and how they connect to the world around them. This psychology ultimately plays a role in how they behave—how they shop, discover, and connect with others.

In some implementations, to determine an archetype of a user, the user can be provided with an ability to select an archetype that the user believes the user can be associated with. In alternative implementations, to determine archetype(s) of the user, the user can be provided with a plurality of questions. The questions can relate to personality of the user, the user's interests, preferences, hobbies, etc. The user's responses to the questions can be received, processed, and the user can be assigned to one or more archetypes based on the user's responses. In some implementations, the user can be allowed to select one or more answers to a particular question, where the answers can be prepared and presented to the user on a user interface for selection by the user. The user can, even after being assigned an archetype (or archetypes), can be provided with an ability to change and/or select one or more archetypes for himself/herself. The user can be assigned and/or select archetype(s) from a plurality of archetypes.

In implementations where the user is assigned archetype(s) based on user's answers to questions, the questions can be arranged using a model (such as based on a regression type analysis), where a particular answer to a question can determine specific follow-up question(s) and where each answer can be assigned a particular weight value or a point. The assignment of points can be static, whereby the points can be predetermined (and do not change) for a particular archetype and/or a question or a series of questions asked of the user when determining an archetype. Alternatively, the assignment of points can be dynamically based, whereby the point value of an answer to a particular question can depend upon user's answers to prior questions. A predetermined combination of the points (e.g., sum of the points, top three amounts of points that can be used to identify and assign archetype(s)) can determine which archetype(s) to assign to the user.

In some implementations, each archetype in the plurality of archetypes can be assigned a particular numerical range, whereby the combination of points falling into an archetype's numerical range can result in that archetype being assigned to the user. In some implementations, answers to questions can also be assigned coefficients that can be applied to the points received for an answer. The coefficients can be assigned to indicate that subject matter contained in an answer to a question or the question itself is more/less important to the user answering the question. For example, a question presented to the user can have a plurality of answers from which the user can select an answer that is most acceptable to the user and, upon selection of such an answer, a point value of X can be assigned to the answer. In some implementations, user's answers to other questions can increase a point value of an answer provided to previous question(s).

Once the archetype is assigned to the user, content that is associated with the archetype can be delivered to the user for viewing by the user on the user's interface. Additionally, the user's prior browsing experiences, information the user has provided through quizzing, polling and account creation and information provided by third party data providers (whether or not related to the user's archetype(s)) can be used to tailor content delivery to the user. Further, life changing events associated with the user can be used to also tailor content delivery to the user. The content can include, but is not limited, website(s) containing articles or publications, shopping websites, social networking websites, search results, etc. Content that can be presented to the user can be tagged with various descriptors, attributes, tags, adjectives, etc. (“descriptors”) that can be associated with the content or one or more of the archetypes (e.g., content relating to caregiving agencies can have “care”, “caregiver”, “health aide”, etc. as descriptors). The descriptors can include various metadata that can describe the content. In some implementations, content providers of a particular content can associate descriptors with the content prior to making the content available. Alternatively, the descriptors can be associated with an already available content. In some implementations, content can be tagged with descriptors related to one or more archetypes (or directly tagged to archetypes) and/or descriptors related to aspects of the content by a third party that can evaluate content and assign descriptors based on such evaluation. Such evaluation and/or assignment can be manual and/or automatic. In some implementations, content can be tagged by users as part of their browsing experience. In some implementations, content can be tagged by the browsing experiences of users by the content being tagged in response how users who are assigned to one or more archetypes interact with the content. Based on the tagging of the content and the classification of users into one or more archetypes, a user's experience of browsing content itself can be tailored to correspond with the lifestyle, preferences, interests, etc. of the user.

In some implementations, when content is presented to the user, the content can be filtered using various filtering mechanisms that can be associated with user's archetype(s). The filtering mechanisms can review the content (by analyzing attributes/descriptors associated with the content) and, upon detection of a particular descriptor matching at least one attribute associated with user's archetype(s) and/or recorded behavior, preferences, interests, etc. whether or not based on prior browsing experiences and/or content requests, can determine whether or not to present the content to the user on the user interface. In some implementations, content can be presented to the user in various ways related or unrelated to the archetype or archetypes assigned to the user.

In some implementations, the user can also browse content (such as products or other items available for purchase) as a combination or a group (e.g., clothing outfits). The content can be tagged with various descriptors identifying relationship of the content to any other content (e.g., a pin-striped suit can be associated with a pin-striped tie) that can be part of a group as well as attributes associated with user's archetype(s). For example, a user can shop for an entire outfit having several items (e.g., pants, a jacket, a shirt, a tie, etc.) that can be initially presented based on one or more archetypes assigned to the user and associated with one or more descriptors tagged to the items in the outfit. The items can also be tagged with descriptors describing what other items they can be matched with and/or other characteristics of the items. Any other types of content can be browsed in groups or individually (e.g., scientific and news articles or publications related to the landing of the Mars “Curiosity” rover).

In some implementations, the user can lock a particular content within a group of contents for the purposes of selecting other content. By locking the content, the content cannot be removed from the group. In the outfit example, various items of the outfit can be locked by the user (indicating that the user wishes to purchase that portion of the outfit) whereas other items can be exchanged or swapped by the user for other items (that might not necessarily be tagged with descriptors that can match attributes associated with one or more archetypes assigned to the user).

In some implementations, content presented to the user can include any type of content. Such content can include products or services, social networking opportunities, articles, videos, images, and/or any other kind of content. As content can be associated with a particular archetype that represents a personality model, presentation of such content related to an archetype can correlate to an entire lifestyle, interest, hobby, etc. that can be associated with that archetype.

Providing such personalized content experiences can afford a number of benefits to users. As a user's content browsing experience is filtered according to the user's archetype(s) (assigned and/or user-selected), prior browsing experiences, personality, preferences, lifestyle, etc., the user can find relevant content easier without having to search through the entire vast amount of content that is available. Further, because the user's content browsing experience is tailored to the user's personality, preferences, lifestyle, etc., content browsing can itself be an entertainment and/or lifestyle activity as opposed to an annoying and boring process that must be performed in order to find content. In at least these ways, providing such personalized content experiences can enhance content browsing for users.

In some implementations, the user can be assigned a plurality of archetypes, where one archetype can be a primary archetype, another can be a secondary archetype, yet another can be a tertiary archetype, etc. Such assignment can be made based on the user's responses to questions, where the primary archetype is assigned based on the highest point value. In some implementations, the assignment of archetypes can be made based on user's prior content browsing experiences, recommendations of content to the user by other users, social networking by the user, user's occupation, user's geographic locality, marital status, gender, education, interests, preferences, hobbies, and/or any other criteria.

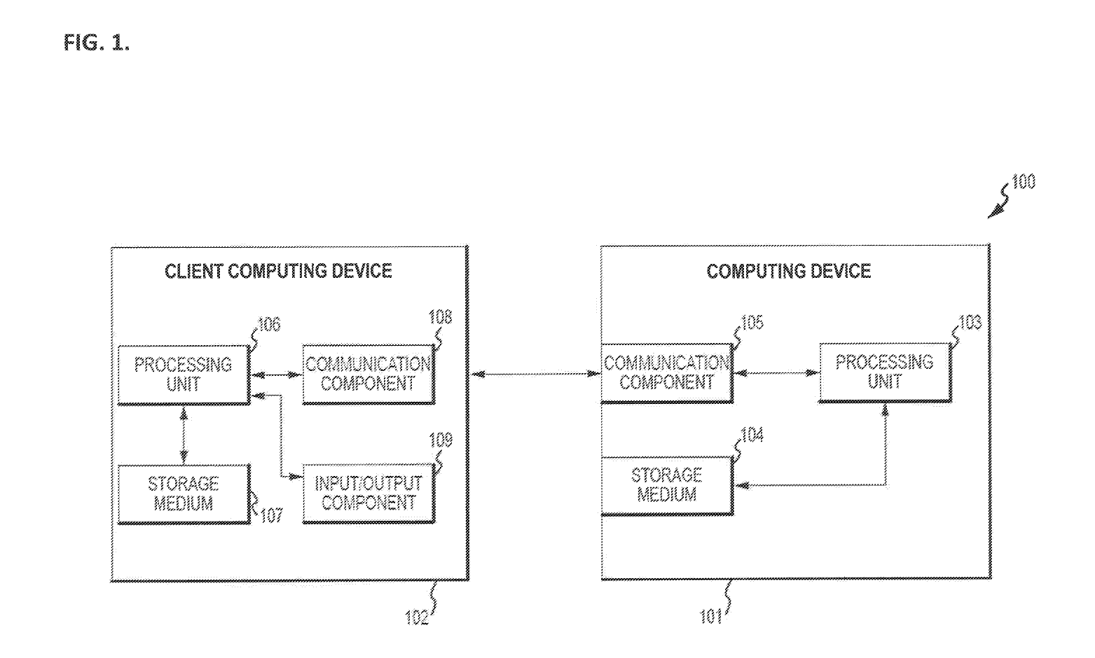

FIG. 1 illustrates an exemplary system 100 for providing personalized content experience to users based on archetypes, according to some implementations of the current subject matter. The system 100 can include a computing device 101 and a client computing device 102. The computing device 101 and/or the client computing device 101 can be any kind of computing device such as one or more server computers, laptop computers, desktop computers, tablet computers, mobile computing devices, cellular telephones, smart phones, personal digital assistants, and/or any other computing device and/or a group of interrelated computing device (such as a cloud computing configuration).

The computing device 101 can include one or more processing units 103, one or more non-transitory storage media 104 (which can take the form of, but is not limited to, a magnetic storage medium, an optical storage medium, a magneto-optical storage medium, a read only memory, a random access memory, an erasable programmable memory, a flash memory, etc. and/or any combination thereof), and one or more communication components 105. The processing unit 103 can execute instructions stored in the storage medium in order to perform one or more of a variety of different operations related to operation of the computer device, such as communicating with the client computing device 102 via the communication component 105.

The client computing device 102 can include one or more processing units 106, one or more non-transitory storage media 107 (which can take the form of, but is not limited to, a magnetic storage medium, an optical storage medium, a magneto-optical storage medium, a read only memory, a random access memory, an erasable programmable memory, a flash memory, etc. and/or any combinations thereof), one or more communication components 108, and one or more input/output devices 109 (such as one or more display screens, keyboards, touch screens, touch pads, computer mice, printers, and/or other such input and/or output device for receiving input from and/or presenting output to a user). The processing unit 106 can execute instructions stored in the storage medium in order to perform one or more of a variety of different operations related to operation of the client computer device, such as communicating with the computing device 101 via the communication component 108, executing a web browser application and/or other such software application for communicating with the computer device, and/or other such operations of the client computer device.

In some implementations, the computing devices 101 and 102 can be connected via a communication network, which can include, but is not limited, to wired, wireless, and/or any other components. The communication network can include a wireless network, a wired network, a local area network (“LAN”), wide area network (“WAN”), metropolitan area network (“MAN”), the Internet, an intranet, an extranet, and/or any other communications network and/or medium. Further, the computing devices 101 and/or 102 can constitute a number of discrete computing devices or can be part of the same computing device.

In some implementations, to determine user's archetype(s), the computing device 101 can transmit a plurality of questions to the client computing device 102 via the communication component 105. The client computing device 102 can present the questions to the user via the input/output component 109. The user can provide responses to the questions via the input/output component 109. The client computing device 102 can transmit the user's responses to the computing device 101 via the communication component 108. The computing device 101, based at least on the user's responses, can assign one or more archetypes, or personality models, to the user. The device 101 can also be used to rank archetypes that can be assigned to the user based on user's responses (and/or any other information) and assign designations to the archetypes (e.g., primary, secondary, tertiary, etc.) of the user.

The computing device 101 can also present the user with an ability to select particular archetype(s) that the user believes to be his/her archetype(s). For that, the device 101 can transmit to the device 102 an indication of a plurality of available archetypes for display to and selection by the user on the user interface of the device 102. Using the user interface of the device 102, the user can select one or more archetypes from the displayed archetypes, whereby the device 102, upon receiving user's selections, can transmit the selections to the device 101 for processing/storage. The user can also indicate (upon, for example, being prompted) which archetype is user's primary, secondary, tertiary, etc. Such indication can also be transmitted by the device 102 to the device 101 for processing/storage. User's indications can be used in filtering and ranking of content whose descriptors match one or more attributes associated with the archetype(s).

As stated above, the archetypes can be abstract representations of different personalities that group different kinds of people into one or more similar models. Though every person is unique, groups of different people (people who all have a similar type of personality and/or live a similar type of lifestyle) can have certain personality characteristics in common such that most or all people can be classifiable into a relatively small number of different categories, represented by the archetypes. These archetypes can define a general predictive model about various people who are grouped into that model, grouped based on the similarities the various people they share and overlooking some of their minor differences. As such, people associated with a particular archetype can have similar personalities, lifestyles, life passages, life phases, and so on. Moreover, when a user provides the website information about a life passage or phase of life, users experiencing that life passage can also have similarities with other users moving through the same phase of life, which can allow for a more predictive tool.

One implementation of such a plurality of archetypes can include, but are not limited to, an artist, an athlete, a rebel, a caregiver, an avid follower of fashion, a queen (or king)/executive, a spiritual, an intellectual, an advocate, and/or any other archetype and/or combination of archetypes. For example, a user can be grouped under the caregiver model if that user is generally giving, caring, loving, and/or feels a need to be needed. Based on the archetype or archetypes that users are assigned to, assumptions can be made regarding their individual personalities, interests, behaviors, hobbies, content preferences, etc. In some situations, user's individual personalities, interests, behaviors, hobbies, content preferences, etc., can correspond to other people who are assigned to that archetype or archetypes.

The computing device 101 can also tag content that can be presented to users with various descriptors (or directly tag the content to one or more archetypes), such as various adjectives or attributes, that are associated with one or more of the archetypes or associated with various characteristics of the content. In some implementations, content can be tagged by content providers that make the content available to others, Internet search engines (or other search engines), third parties evaluating content, users, etc. Content can also be tagged in response to information learned from a user's previous content browsing experience, recommendations of content to the user by other users, social networking by the user, user's occupation, user's geographic locality, marital status, gender, education, interests, preferences, hobbies, quizzes, polls, third party acquired information and/or any other criteria. In some implementations, user's archetype(s) (whether assigned and/or user-selected) can provide at least one assumption as to the content that can be presented to the user, with a user's life passage providing additional predictability. The user's content browsing experience (whether or not based on the user's active and/or passive exploration/searching of content, recommendation of content by other users, receipt of content from other users, etc.) can tailor the content that can be presented to the user by providing a deeper understanding of what content the user would like to be presented with. For example, users having a “creative” primary archetype can be interested in different type contents (e.g., painting and theater) based on the users' exploration/searching of content, recommendation of content by other users, receipt of content from other users, etc. In some implementations, the content can be tagged by users as potentially being of interest to other users, e.g., a first user taking a picture of a building on a street and putting a tag (e.g., a caption, a description, etc.) indicating that it may be of interest to a second user, who is an architect. The first user-tagged content can be sent to the second user. When sending content, the first user indicates to the second user under which archetype the content they believe the recipient will enjoy the content. The second user can determine whether or not to accept the content (e.g., by placing the content on the user's personal website) and upon acceptance, the second user's content delivery can be tailored based on the accepted content and the tag that was received with the content. Further delivery of content to the second user can also be tailored based on the fact that the tagged content was received from the first user, i.e., the first user's archetype, interests, hobbies, content browsing experiences, etc. can be used to tailor delivery of content to the second user. The users can create and/or tag content using various devices (e.g., desktop computers, laptop computers, mobile telephones, smartphones, tablet devices, cameras, video cameras, personal digital assistant devices, etc.) and then transmit the created and/or tag content to themselves and/or to other users.

The computing device 101 can also tag content that can be presented to users with various descriptors related to aspects of the content itself and groups which the content can belong to. For example, through a process referred to as “outfitting” a user can be able to browse for entire outfits of items of apparel. As such, the items of the outfit can be tagged with descriptors associated with one or more archetypes, descriptions of the individual items, and/or descriptions of other items that can be grouped with the individual items. Thus, a user can be initially presented with a spring business occasion outfit (such as a pair of shoes, a necklace, a hat, a purse, a top, a skirt, and a watch that all match) based on archetypes assigned to the user and descriptors assigned to the items in the outfit (such as descriptors associated with the archetypes assigned to the user, descriptors indicating that the items are portions of the outfit, and descriptors indicating that the various items can be matched together). The user can then be able to “lock” one or more items of the outfit (such as, a purse), indicating that the user wishes to purchase those items, and “swap” other of the items for different items that include descriptors indicating that they match the locked items (though in some cases they might not include descriptors associated with archetypes assigned to the user).

The computing device 101 can determine whether to present content (such as, products and/or services that are available to the user for purchasing) to the user, such as, in response to a user request for content (e.g., in response to the user entering a search query for a particular content). Based on such determination, the computing device 101 can filter content based on at least on the archetype or archetypes assigned to the user, the attributes associated with the user's archetype(s) and the descriptors associated with the content. The computing device 101 can then provide the filtered content to the computing device 102 for presentation to the user or the archetype(s) the user has asked to search within. As a result of the filtering, the content presented can be content that has a higher probability of being relevant to lifestyle or personality of the user.

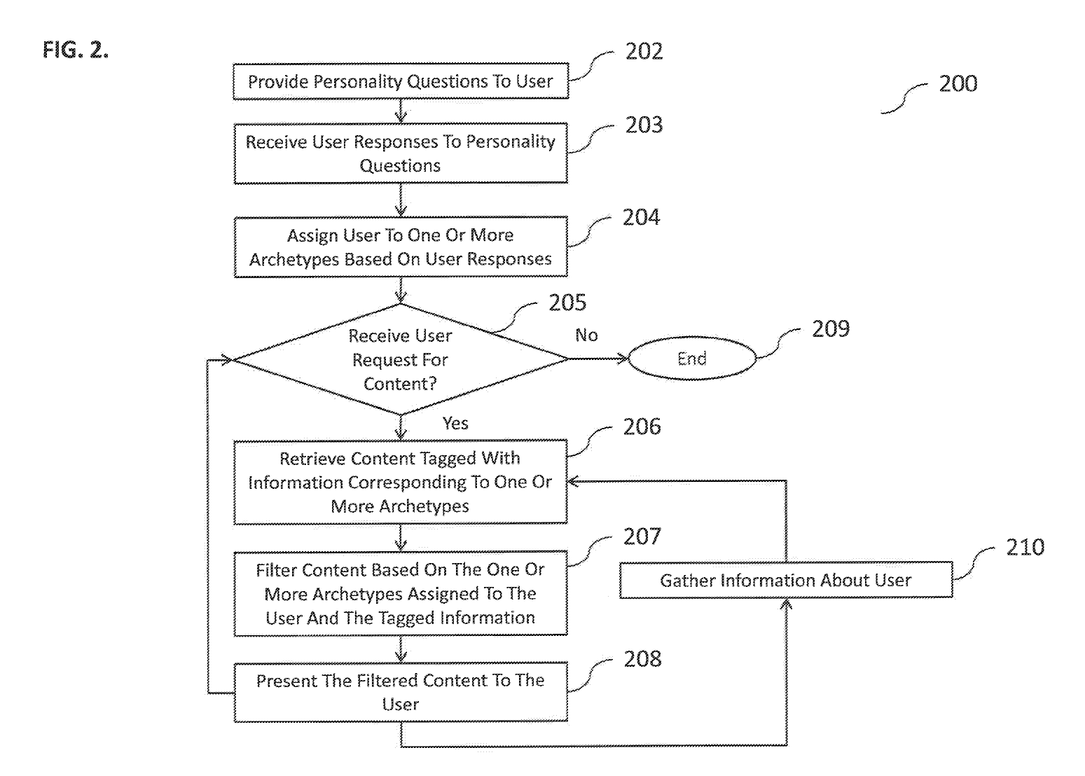

FIG. 2 illustrates a method 200 for providing personalized content experience to users based on archetypes. The method 200 can be performed by the computing device 101 shown in FIG. 1. At 202, the computing device 101 can provide one or more questions to the computing device 102, which can display such question to the user. At 203, the computing device 102 can receive one or more user responses to the questions, which can be forwarded to the device 101 for processing. At 204, the computing device 101 can assign the user to one or more archetypes based at least on the received user responses. At 205, the computing device 101 can determine whether or not a user request (e.g., an Internet search query entered into an Internet search engine) to search for and present content has been received. If not, the method 200 terminates, at 209.

If the request for content is received, the computing device 101 can analyze the request and, based on the analysis, can retrieve content that can relate to the request and includes descriptors that can match at least one attribute of one or more archetypes assigned to the user. In some implementations, the content can be actively searched by the user via an entry of a search query. Alternatively, the content can be passively explored/viewed by the user, such as by exploring information about an archetype and content that can be associated with it. The content that can be presented to the user (whether or not as a result of an active or a passive search) can be curated based on user's archetype(s), prior content browsing experience, content recommendations by other users, interests, preferences, hobbies, etc. In some implementations, a search engine can be used to obtain content, which can be filtered or curated based on user's archetype(s), prior content browsing experience, content recommendations by other users, interests, preferences, hobbies, etc.

At 207, the computing device 101 can filter content based on at least one attribute of the one or more archetypes assigned to the user and the descriptors of the content. Other criteria can be used to filter content, at 207. As one non-limiting example, a user can change his or her assigned archetype manually, prior to the operation at 207. In such a case, the user-assigned (or changed by the user) archetype can be used to filter content. Likewise, the user can specify a temporary or a “filter-only” archetype using which content (or particular types of content) can be filtered. This can be useful, for example, when a user wishes to filter only a particular type of content based on a user-assigned archetype, or wishes to temporarily see content associated with particular archetypes but does not wish to permanently change his or her archetype. Users can filter on other archetypes without changing their own archetype, as well.

At 208, the computing device 101 can provide the filtered content to the computing device 102 for displaying to the user on the user interface of the computing device 102. Once the filtered content has been delivered to the user, the computing device 101 can gather information about the user and user's browsing experiences, at 210. This can include the content that has been delivered, recommended to the user by other users, user's browsing activities, user's interests, hobbies, preferences, etc. Such gathering of information allows the computing device 101 to fine-tune the future filtering and presentation of content to the user. Once the computing device 101 has been updated with this information, the method 200 can return to 205, where the computing device 101 can determine whether or not another user request to present content has been received. As stated above, the user's request for content can be an active search (e.g., a search query), a passive exploration of content (e.g., such exploration of content that can be related to an archetype, another user, etc.), recommendation of content by other user, etc.

In some implementations, the system 100 (shown in FIG. 1) can include a single computing device or a plurality of computing device that can perform method 200 (shown in FIG. 2. Although the method 200 is illustrated and described above as including a particular set of operations performed in a particular order, it is understood that this is for the purposes of example. In some implementations, the method can include different sets of operations and/or operations performed in a different order without departing from the scope of the present disclosure. For example, the operation of retrieving content tagged with descriptors is illustrated and described above as being performed after a request for content is received and before content is filtered. However, in some implementations, tagging of content can be performed at various times preceding one or more other operations of the method 200, subsequent to one or more other operations of the method 200, and/or concurrently with one or more other operations of the method 200.

Returning to FIG. 1, each of the questions can be provided with one or more selectable responses. In some implementations, the user can select more than one of the possible selectable responses for a question. In some implementations, each response can be associated with a particular point value. Point values can be accumulated based on the answers to questions that are selected by the user to determine user's archetype(s). The point values can be static or predetermined for each answer to a question. Alternatively, the point values can be dynamic and can be changed depending on answers to other questions selected by the user. Upon user's indication that the subject matter of an answer (or question) is more/less important, a coefficient value can be assigned to the user. The coefficients can also be static or predetermined for each answer to a question. Alternatively, the coefficients can be dynamically assigned, e.g., based on user's answers to other questions, specific questions, etc.

Each of the selectable responses can be associated with one or more of the archetypes and, as stated above, user's selection of a response can result in an accumulation of points for the associated archetype or archetypes. In some implementations, assigning one or more archetypes to the user can include determining which archetype or archetypes have the most accumulated points based on the user responses.

In situations where one or more archetypes accumulate a similar number of points, one or more rules can be evaluated to determine which archetype or archetypes to assign. For example, such a rule can specify to assign the user to the rebel archetype over the caregiver archetype. In another example, such a rule can specify to assign the user to the queen (or king)/executive archetype over the spiritual archetype if both archetypes have accumulated the exact same number of points.

In some implementations, the questions can be grouped into various categories. Such categories can include, but are not limited to, classifications such as fashion, home, entertaining, gifting, health-exercise, and/or health-diet. In such cases, the point accumulations for each of the archetypes can be evaluated for each category (and/or groups of categories). The final assignment of archetype or archetypes can then be based on how many categories a respective archetype has more points in. For example, user's answers to questions that indicate that the user is more interested in fashion and celebrities as opposed to health fitness routines promoted by celebrities can generate more points for the user in the fashion and entertaining groups and can potentially be associated with an avid follower of fashion archetype as opposed to an athlete archetype (which can correspond to more points being accumulated in the health-exercise or health-diet groups).

In some implementations, multiple archetypes can be assigned to the user based on at least one of the user responses to the questions. In such cases, the assigned archetypes can be ranked in one or more ways. For example, a primary or a dominant archetype can be assigned along with one or more complimentary (and/or secondary, tertiary and/or subsidiary) archetypes. In some cases, such multiple archetype assignments can select all archetypes that accumulate more than a certain number of points or win more than a certain number of point categories and rank the assigned archetypes based on the number of points accumulated and/or the number of point categories won. In other cases, a certain number of archetypes can be assigned and ranked accordingly based on the number of points accumulated and/or the number of point categories won. In some implementations, when multiple archetypes can be assigned, a single archetype can be assigned if no other archetypes received any (or a threshold number, such as ten) of points or won any (or a threshold number, such as two) of categories. For example,

Archetype A corresponds to a minimum of 50 points in answers to category A questions;

Archetype B corresponds to a minimum of 30 points in answers to category B questions;

Archetype C corresponds to a minimum of 20 points in answers to category C questions.

The user accumulated 55 points in question category A, 10 points in category B, and 25 points in category C, thus, the user's primary archetype is Archetype A and the user's secondary archetype is Archetype C. In some implementations, as the user did not reach a required minimum in category B, Archetype B cannot be assigned to the user. However, Archetype B can be assigned to the user either via user's own selection of Archetype B or through various other methods (accumulation of points that can be indicative that user's archetype is Archetype B).

In some implementations, an interface can be presented to the user that can enable the user to alter the archetypes that have been assigned to the user. Such an interface can enable the user to answer the personality questions over again, directly add and/or subtract assigned archetypes, and/or otherwise alter the archetypes that are assigned to the user (determined for the user or user-selected). Such an interface can also enable a user to allow other users to modify the user's archetype assignments by answering personality questions about the user.

In some implementations, the user's responses to the personality questions and/or the archetypes assigned to the user can be stored in the storage medium 104, the storage medium 107, and/or other such storage media.

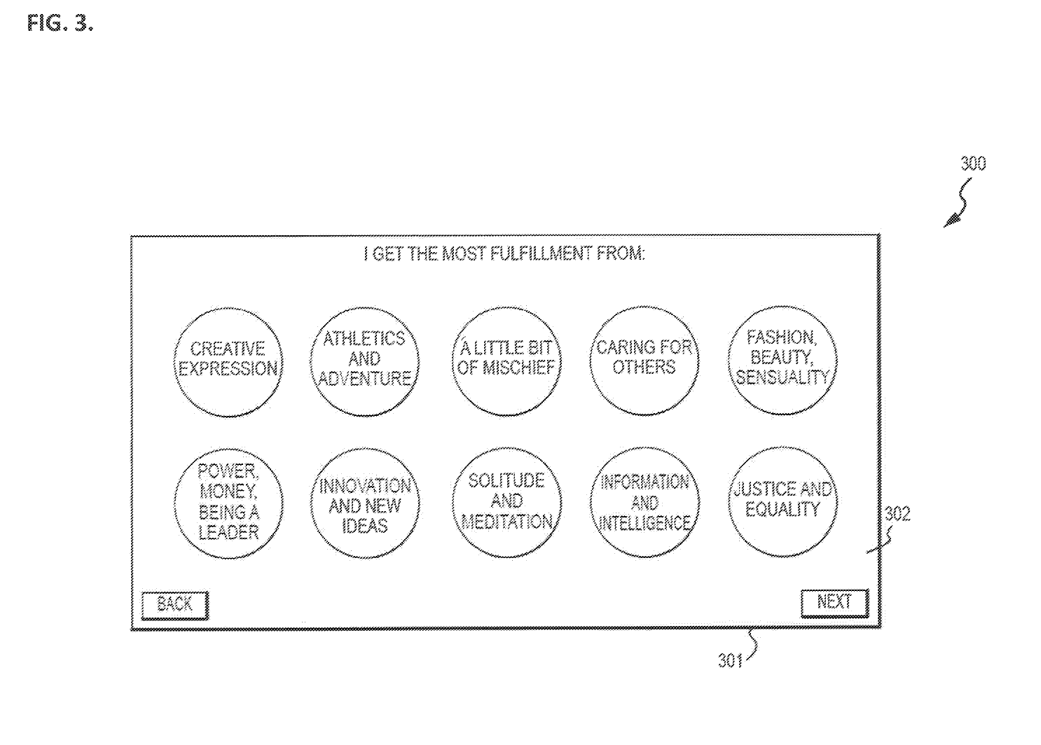

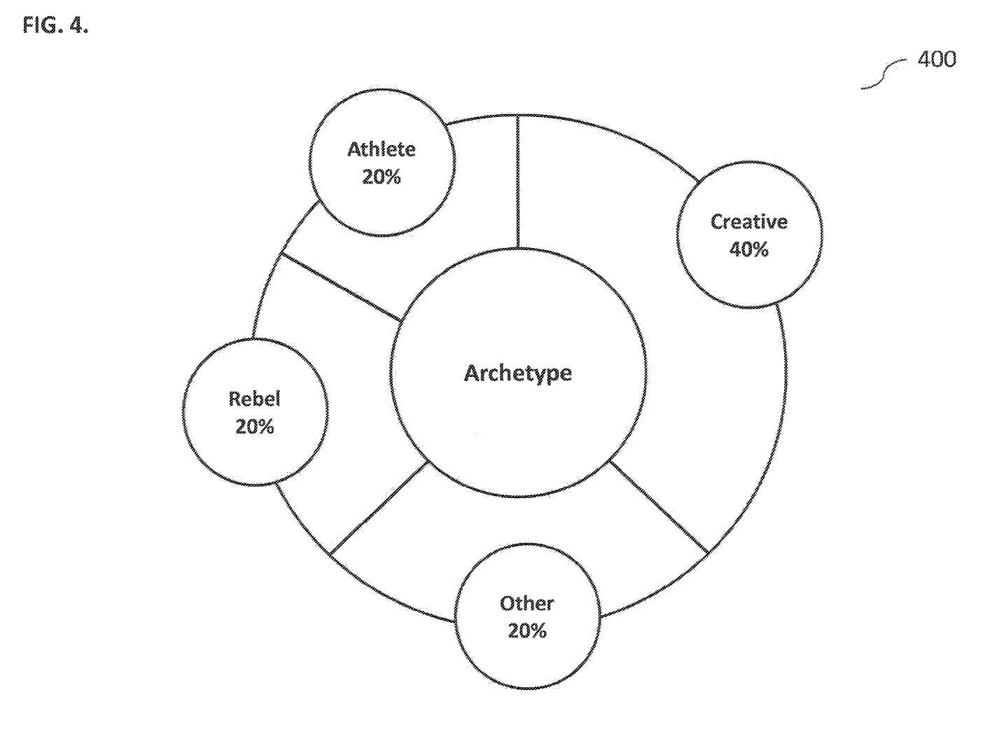

FIG. 3 illustrates an example of a presented personality question 300, according to some implementations of the current subject matter. As illustrated, a personality question (“I get the most fulfillment from”) 302 is graphically displayed on a display screen 301 (which can be a user interface of the computing device 102 shown in FIG. 1). A plurality of selectable responses (e.g., “Creative expression”, “Athletics and Adventure”, etc.) can be displayed on the display screen 301 for selection by the user. For example, the user can select an answer by clicking on it using user's computer mouse (or punching a key on a keyboard, and/or in any other fashion). Upon user's selection of the answer, the computing device 102 (shown in FIG. 1) can detect the user's response and forwarded to the computing device 101 (shown in FIG. 1) for processing/storage. The user can be provided with an option to select more than one answer and, in some implementations, the number of selectable answers can be limited (e.g., to three). The user can also change user's answers by de-selecting a selected answer and selecting another answer. Upon receiving de-selection of answer and selection of another answer, the computing device 102 can appropriately alert computing device 101. Further, after answering the currently displayed question, the user can proceed to the next question (e.g., by clicking “Next”) that can be displayed on the user interface. The user can also go back to the previous question and revise user's answers. Once, the user finishes answering all questions presented to the user, the system 100 can display user's archetype(s), as shown in FIG. 4. In some implementations, processing of user's answers can be in real time or delayed until all answers to all questions are received. The questions and selectable answers that can be presented to the user can be arranged in a predetermined pattern and/or can be changed dynamically based on user's answers to previous questions.

FIG. 4 illustrates an example of an interface 400 presenting the results of a user's responses to the personality questions, according to some implementations of the current subject matter. As illustrated, an interface 400 providing the user's assigned archetypes can be graphically displayed on a display screen (which can be a user interface of the computing device 102 shown in FIG. 1). As shown in FIG. 4, the user's archetype can be 40% Creative, 20% Athlete, 20% Rebel, and 20% Other. The Creative aspect of the user's archetype can indicate that the user like to create, seeks inspiration and needs to express himself/herself. The Athlete aspect can indicate that the user is physical, drawn to sports, and is an adventurous spirit. The Rebel aspect can indicate that the user is fearless, and likes anything out of the ordinary. The Other aspects can be indicative of other user's interests, hobbies, preferences, etc.

Returning to FIG. 1, in implementations where the user is assigned to more than one archetype, content that is filtered based at least on one or more archetypes assigned to the user and descriptors associated with the content can be ranked. For example, if one archetype is ranked as a primary or a dominant and one or more others are ranked as complimentary (e.g., secondary, tertiary, etc.), content having descriptors matching attributes associated with the dominant archetype can be ranked higher and/or displayed first on the user interface than content having descriptors matching attributes associated with complimentary archetypes. Further, content having descriptors matching attributes associated with a certain number of assigned archetypes (such as three or two) can be ranked higher and/or displayed first on the user interface than content having descriptors matching attributes associated with a smaller number of assigned archetypes (such as one). In some implementations, the filtered content can be presented/displayed to the user in order of rank.

The computing device 101 can provide a user interface to the user that can enable the user to alter the filtering of the content. The interface can allow the user to alter which of the user's assigned archetypes are used to filter the content, select one or more archetypes other than assigned archetypes by which to filter content, search for content, narrow results (such as by brand, occasion, type, size, price, color, relevance, or other product criteria in cases where the content constitutes products), and/or other such ways that a user can alter the filtering of the content.

The following are non-limiting examples of descriptors that can be tagged to content, which are provided for illustrative purposes only. Descriptors such as edgy and/or unique can be associated with a rebel archetype. Descriptors such as unique and/or feminine eclectic can be associated with an artist archetype. Descriptors such as trendy can be associated with a queen (or king)/executive archetype. Descriptors such as sexy and attention-getting can be associated with both a rebel and an avid follower of fashion archetypes. Descriptors such as sophisticated, classic, and/or professional can be associated with an intellectual archetype, an advocate archetype, an avid follower of fashion archetype, and an athlete archetype. Descriptors such as updated, comfortable, and/or casual feminine can be associated with a caregiver archetype, a spiritual archetype, a visionary archetype, an advocate archetype, and an athletic archetype. Such descriptors can be stored as part of the content, in one or more informational files that describe the content (e.g., metadata), and/or in various other ways that descriptors can be associated with content. In some implementations, content can be directly tagged to particular archetypes in addition to and/or in alternative to tagging content with descriptors associated with archetypes. Additionally, in some implementations, content can be tagged with various characteristics of the content, such as clothing products being tagged with descriptors related to color of the clothing products and/or types of clothing items that complement the clothing products.

In some implementations, content can constitute a variety of different kinds of content, such as content that is explored/searched for by the user, user-generated content, user-tagged content, etc. For example, the content can include articles, products or services, social networking services, videos, images, and/or any other such kind of content. In some implementations, the computing device 101 can be a web server that provides a web site that includes articles, products or services, social networking services, videos, images, and/or other such content. In some implementations, the client computing device 102 can execute a web browser in order to enable the user to interact with the web site provided by the computer device.

In some implementations, the content that can be presented to the user can include a personalized horoscope and/or other personalized information, e.g., personalized financial investment plan, personalized retirement plan, personalized weight loss program (e.g., dieting and exercise regimen), and/or any other personalized information. By way of non-limiting example, the personalize horoscope can be generated based on the user's personal information, such as user's name, date of birth, place of birth, etc. Based on that information, user's astrological sign (e.g., Zodiac, etc.) can be determined. Then, using user's archetype(s), user's personalized horoscope can be dynamically determined for a specific day, a week, a month, a year, and/or any other period of time. The dynamic horoscope generation can be also based on the content that is presented to the user, user's content experiences, recommendations of content, etc. Further, content delivery to the user can be further tailored based on user's dynamically generated horoscope.

In some implementations, the computing device 101 can implement a web site for providing a personal curative service across content, commerce and community. The web site can enable users to create an account (and/or sign in utilizing a social networking service or other service), answer personality questions in order to assign one or more archetypes to the user, store assigned archetypes, store personal and behavior information (such as, date of birth, location, address, financial information, purchase history, wish lists regarding products or services the user wishes to purchase, categories of interest, preferences, hobbies, and/or any other such information), search for products or services to purchase, purchase products or services, and/or provide other content browsing/delivery experience. In some implementations, products available via the web site can be obtained from one or more vendors. Orders corresponding to one or more such vendors can be fulfilled via an affiliate program, a drop ship arrangement (such that the user might not be aware that any other merchant other than the merchant associated with the web site is involved in any transactions), sold and order fulfillment directly by the website and/or any other arrangement.

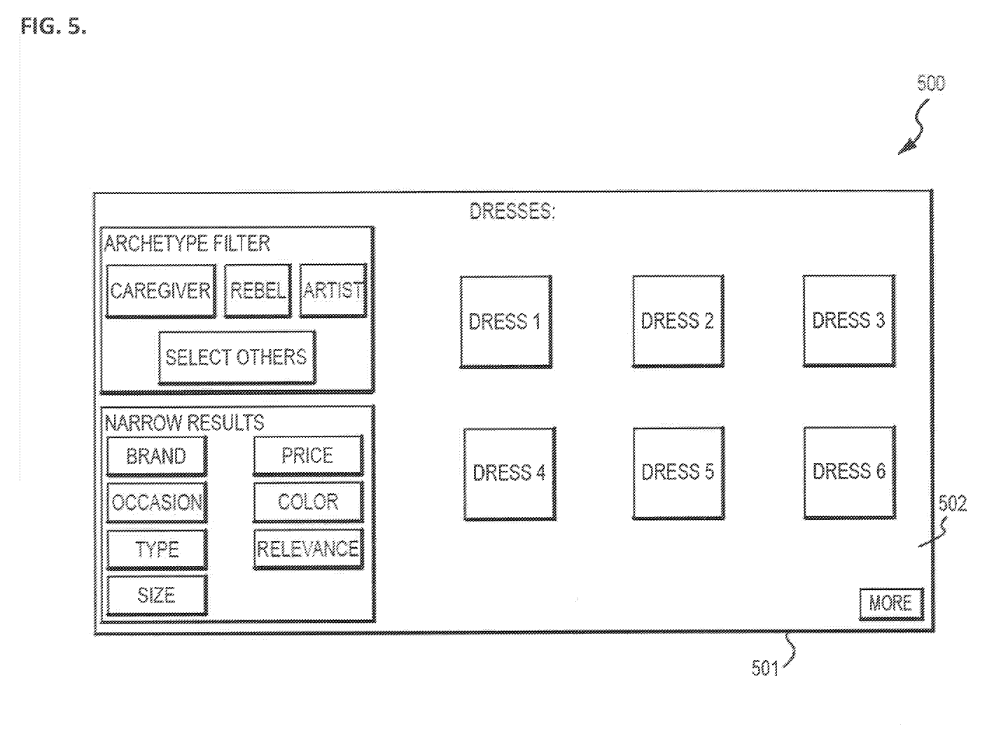

FIG. 5 illustrates an example of a purchasing website 500 where a user has selected to search for dresses, according to some implementations of the current subject matter. As illustrated, an interface for a purchasing website 502 can be presented on a display screen 501. As shown in FIG. 5, the interface for the purchasing website can include products filtered according to archetype associations, i.e., a first sub-interface that the user can utilize to control the archetypes utilized to filter the search results, and a second sub-interface that the user can utilize to otherwise sort the results (such as by category of interests, preferences, hobbies, etc., and/or, for example, in connection with commerce, brand, price, occasion, color, type, category, relevance, size, and so on). Although FIG. 5 presents the interface for the purchasing website where the user has elected to search for dresses, the purchasing website can enable the user to search for products or services based on a variety of criteria (such as occasion, brand, type, category, keyword search, and/or any other way that a user might search for products or services).

The purchasing website can also enable the user to search for products or services by group. For example, some products can be utilized in a group along with certain other products. As such, the purchasing website can enable users to search according to groups. One example of such a group would be computer equipment. Computers, such as personal computers, are often utilized along with peripherals (such as printers, mice, scanners, monitors, and/or other such peripherals). However, certain brands or types of peripherals can only be compatible with certain personal computers and/or certain other peripherals. Such compatibility information can be included in the descriptors associated with the products. The purchasing website can enable the user to search for a personal computer and associated peripherals, as a group, that are all compatible. The purchasing website can also enable to user to lock certain members of the group that the user can wish to purchase while swapping out other members of the group for other components of that type that are also compatible with the remainder of the group (indicated by one or more descriptors tagged to the components). Such compatibility information and/or type for determining other items when swapping can be included in the descriptors associated with the components.

Another example of such a group can include clothing outfits. Certain items of clothing and accessories can be commonly worn together. For example, tops and bottoms can be frequently matched with accessories (such as purses, necklaces and/or other jewelry, and/or other accessories) and/or with each other. The purchasing website can enable the user to search for an entire outfit (and can enable the user to search by type of outfit, occasion for the outfit, season for the outfit, and/or any other search criteria the user can utilize to select an entire outfit) where all the items of the outfit match. The purchasing website can also enable to user to lock certain members of the group that the user can wish to purchase while swapping out other members of the group for other items of that type that also match the remainder of the group (though such other items can or might not be tagged with descriptors associated with an archetype assigned to the user). Such matching information and/or type for determining other members when swapping maybe included in the descriptors associated with the products. Such outfit searching can be filtered based on relationships between items of outfits and various archetypes assigned to the user. Alternatively, the purchasing website can enable the user to search for outfits without filtering based on assigned archetypes.

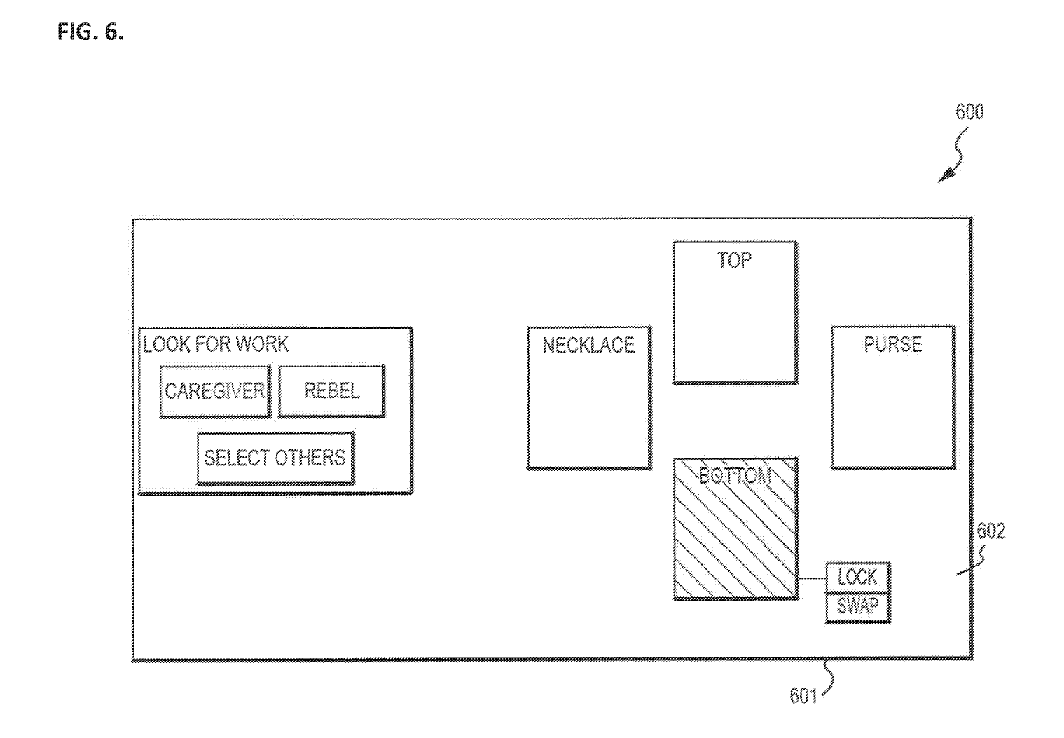

FIG. 6 illustrates an example of a purchasing web site where a user has selected to search for entire outfits that are associated with work occasions, according to some implementations of the current subject matter. As illustrated, an interface for a purchasing website 602 is presented on a display screen 601. As also illustrated, the purchasing website in this example presents an outfit as a combination of a top, bottom, necklace, and purse. The user in this example has selected the bottom, causing the website to present a menu enabling the user to lock the bottom for purchase and/or swap the displayed bottom out for another bottom that is associated with the assigned caregiver and rebel archetypes and matches the currently displayed necklace, top, and purse (though in other cases swapping can swap the displayed bottom out for another bottom that matches the currently displayed necklace, top, and purse but is not associated with the assigned caregiver and/or rebel archetypes).

In some cases, the displayed outfit can be combined with one or more images of the user and/or a portion of such an image. In this way a user can be able to better visualize how the user will look in such an outfit as the user shops. The purchasing website can also enable to user to lock certain portions of the outfit that the user can wish to purchase while swapping out other portions of the outfit for other similar items of that type that are also compatible with the remainder of the outfit. Such compatibility information and/or type for determining other outfit items to select when swapping maybe included in the tags associated with the portions of the outfit.

Returning to FIG. 1, in some implementations, the computing device 101 can implement a website for providing social networking services to users based on archetypes. Such a social networking site can enable users to communicate with each other (such as via messaging, “friending” other users, engaging in chat sessions with other users, sharing purchase histories with other users, sharing wish lists with other users, browsing through content together with other users, sharing information regarding archetypes assigned to a user with other users, answering personality questions about other users to modify archetypes assigned to those users, creating content to share with other users, and so on). The social networking site can enable communication between users regardless of the archetypes assigned to the various users. By allowing social interaction, user boards, and profiles to be based on archetypes, the website can empower a user to express his/her full persona and/or identity to other users and under the persona and identity of others. Further, algorithms to suggest friends to users can take into account not just traditional mechanisms, such as mutual friends, organizations, etc., but can take into account who the user is, e.g., user's archetype(s), life passage(s), behavioral pattern(s), etc.

The social networking site can also provide users the ability to interact with other users who have been assigned one or more archetypes. Users can be able to interact with other users who have been assigned one or more of the same archetypes as the user and/or can be able to interact with other users who have been assigned different archetypes from the user. In some cases, the other users might not personally interact with the user.

In still other implementations, the computer device can implement a website that integrates a purchasing web site, a social networking web site, an informational website, and/or other kinds of websites. Such functions can be separately accessible or can be integrated into a unified web experience for the user. In this way, the user can be able to purchase goods and services, interact with other users, read articles, and/or browse other content in a way that can or might not be related to one or more archetypes assigned to the user.

As can be understood, the current subject matter is not limited to the above exemplary implementations and can be used to search, locate and present any content to users that can have one or more archetypes assigned to them (either determined for the user or selected by the user). The archetypes can be determined for the user based on user's answers to various questions that can relate to user's personality, interests, hobbies, preferences, prior content browsing experiences, recommendations of content to the user by other users, social networking by the user, user's occupation, user's geographic locality, marital status, gender, education, and/or any other criteria. The archetypes can also be selected by the user and/or changed by the user. Further, the archetypes can be ranked based on the user's answers to questions. Based on the determined archetypes and/or their corresponding ranking, the content can be presented to the user through matching of content's descriptors with attributes of the assigned user archetypes and browsing experiences, content recommendations, content creation, etc. The content can also be ranked based on the ranking of archetypes.

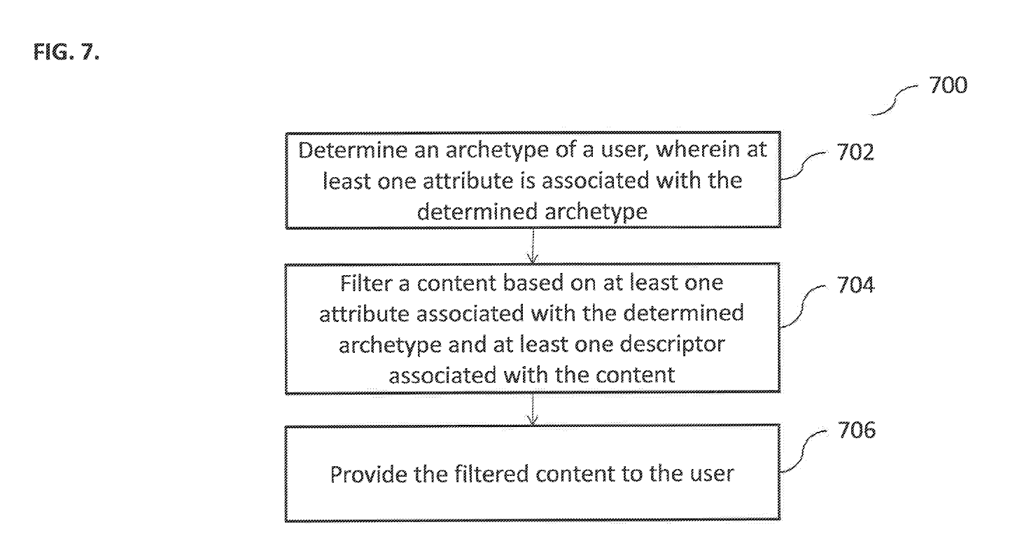

FIG. 7 illustrates an exemplary method 700, according to some implementations of the current subject matter. The method 700 can be performed by one or more components of the system 100 shown in FIG. 1. At 702, an archetype of a user can be determined. The archetype can be associated with at least one attribute. At 704, content can be filtered based on at least one attribute associated with the determined archetype and at least one descriptor associated with the content. In some implementations, the content can be specifically requested by the user via an entry of a search query. Alternatively, the content can be passively explored by the user, such as by viewing information associated with an archetype (not necessary user's archetype), other users' archetypes, other users' personal websites, etc. The content can also be recommended or sent to the user by other users. In some implementations, the content that can be presented to the user can include a descriptor that can match an attribute of at least one existing archetype. At 706, the filtered content can be provided to the user. At least one of the determining, the filtering, and the providing can be performed by at least one processor.

In some implementations, the current subject matter can include one or more of the following optional features. The determining can include selecting, by the user, the determined archetype from a plurality of archetypes. The determining can also include providing at least one question to the user, receiving a response to the provided at least one question from the user, and assigning, based on the received response, the determined archetype from a plurality of archetypes to the user.

In some implementations, the method can include associating at least one descriptor with the content, wherein the at least one descriptor identifies content.

In some implementations, the filtering can include comparing at least one attribute of the determined archetype with at least one descriptor of the content and determining, based on the comparing, whether at least one attribute of the determined archetype matches at least one descriptor of the content. In some implementations, the providing can include providing the filtered content to the user based on the determination that at least one attribute of the determined archetype matches at least one descriptor of the content.

In some implementations, the method can further include determining another archetype of the user and ranking the determined archetype and another determined archetype. At least another attribute can be associated with another determined archetype. The providing can include providing the filtered content in a ranking order based on the ranking of the determined archetype and another determined archetype.

In some implementations, the method can also include receiving a request to modify the determined archetype assigned to the user and modifying, based on the receiving, the determined archetype assigned to the user.

In some implementations, the method can also include re-filtering the filtered content based on at least one archetype that is different from the determined archetype and providing the re-filtered content to the user.

In some implementations, the method can also include sorting the filtered content based on at least one criteria and providing the sorted content to the user.

In some implementations, the method can also include identifying a group of first contents having at least one relationship to each other, determining a second content related to the group of first contents, and providing the second content to the user. The method can also include modifying the identified group of first contents by modifying at least one first content in the identified group of first contents, determining a third content based on the modified group of first contents, and providing the third content to the user. The group of first contents can be identified based on the determined archetype of the user.

In some implementations, filtering of content can include filtering the content based on a previous content provided to the user.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method for providing personalized content experience, the method comprising:
determining an archetype of a user, wherein at least one attribute is associated with the determined archetype;
filtering a content based on the at least one attribute associated with the determined archetype and at least one descriptor associated with the content; and
providing the filtered content to the user;
wherein the at least one of the determining, the filtering, and the providing is performed by at least one processor.

2. The method according to claim 1, wherein the determining further comprises selecting, by the user, the determined archetype from a plurality of archetypes.

3. The method according to claim 1, wherein the determining further comprises providing at least one question to the user;
receiving a response to the provided at least one question from the user; and
assigning, based on the received response, the determined archetype from a plurality of archetypes to the user.

4. The method according to claim 1, further comprising associating the at least one descriptor with the content, wherein the at least one descriptor identifies content.

5. The method according to claim 1, wherein the filtering further comprises
comparing the at least one attribute of the determined archetype with the at least one descriptor of the content; and
determining, based on the comparing, whether the at least one attribute of the determined archetype matches the at least one descriptor of the content.

6. The method according to claim 5, wherein the providing further comprises
providing the filtered content to the user based on the determination that the at least one attribute of the determined archetype matches the at least one descriptor of the content.

7. The method according to claim 1, further comprising
determining another archetype of the user, wherein at least another attribute is associated with the another determined archetype; and
ranking the determined archetype and the another determined archetype.

8. The method according to claim 7, wherein the providing further comprises
providing the filtered content in a ranking order based on the ranking of the determined archetype and the another determined archetype.

9. The method according to claim 1, further comprising:
receiving a request to modify the determined archetype assigned to the user; and
modifying, based on the receiving, the determined archetype assigned to the user.

10. The method according to claim 1, further comprising:
re-filtering the filtered content based on at least one archetype different from the determined archetype; and
providing the re-filtered content to the user.

11. The method according to claim 1, further comprising:
sorting the filtered content based on at least one criteria; and
providing the sorted content to the user.

12. The method according to claim 1, further comprising:
identifying a group of first contents having at least one relationship to each other;
determining a second content related to the group of first contents; and
providing the second content to the user.

13. The method according to claim 12, further comprising:
modifying the identified group of first contents by modifying at least one first content in the identified group of first contents;
determining a third content based on the modified group of first contents; and
providing the third content to the user.

14. The method according to claim 12, wherein the group of first contents is identified based on the determined archetype of the user.

15. The method according to claim 1, wherein the filtering further comprises filtering the content based on a previous content provided to the user.

16. A system comprising:
at least one programmable processor; and
a machine-readable medium storing instructions that, when executed by the at least one programmable processor, cause the at least one programmable processor to perform operations comprising:
determining an archetype of a user, wherein at least one attribute is associated with the determined archetype;
filtering a content based on the at least one attribute associated with the determined archetype and at least one descriptor associated with the content; and
providing the filtered content to the user.

17. The system according to claim 16, wherein the determining further comprises selecting, by the user, the determined archetype from a plurality of archetypes.

18. The system according to claim 16, wherein the determining further comprises providing at least one question to the user;
receiving a response to the provided at least one question from the user, and
assigning, based on the received response, the determined archetype from a plurality of archetypes to the user.

19. The system according to claim 16, wherein the operations further comprise associating the at least one descriptor with the content, wherein the at least one descriptor identifies content.

20. The system according to claim 16, wherein the filtering further comprises
comparing the at least one attribute of the determined archetype with the at least one descriptor of the content; and
determining, based on the comparing, whether the at least one attribute of the determined archetype matches the at least one descriptor of the content.

21. The system according to claim 20, wherein the providing further comprises
providing the filtered content to the user based on the determination that the at least one attribute of the determined archetype matches the at least one descriptor of the content.

22. The system according to claim 16, wherein the operations further comprise
determining another archetype of the user, wherein at least another attribute is associated with the another determined archetype; and
ranking the determined archetype and the another determined archetype.

23. The system according to claim 22, wherein the providing further comprises
providing the filtered content in a ranking order based on the ranking of the determined archetype and the another determined archetype.

24. The system according to claim 16, wherein the operations further comprise:
receiving a request to modify the determined archetype assigned to the user; and
modifying, based on the receiving, the determined archetype assigned to the user.

25. The system according to claim 16, wherein the operations further comprise:
re-filtering the filtered content based on at least one archetype different from the determined archetype; and
providing the re-filtered content to the user.

26. The system according to claim 16, wherein the operations further comprise:
sorting the filtered content based on at least one criteria; and
providing the sorted content to the user.

27. The system according to claim 16, wherein the operations further comprise:
identifying a group of first contents having at least one relationship to each other;
determining a second content related to the group of first contents; and
providing the second content to the user.

28. The system according to claim 27, wherein the operations further comprise:
modifying the identified group of first contents by modifying at least one first content in the identified group of first contents;
determining a third content based on the modified group of first contents; and
providing the third content to the user.

29. The system according to claim 28, wherein the group of first contents is identified based on the determined archetype of the user.

30. The system according to claim 16, wherein the filtering further comprises filtering the content based on a previous content provided to the user.

31. A computer program product comprising a machine-readable medium storing instructions that, when executed by at least one programmable processor, cause the at least one programmable processor to perform operations comprising:
determining an archetype of a user, wherein at least one attribute is associated with the determined archetype;
filtering a content based on the at least one attribute associated with the determined archetype and at least one descriptor associated with the content; and
providing the filtered content to the user.

32. The computer program product according to claim 31, wherein the determining further comprises selecting, by the user, the determined archetype from a plurality of archetypes.

33. The computer program product according to claim 31, wherein the determining further comprises
providing at least one question to the user;
receiving a response to the provided at least one question from the user; and
assigning, based on the received response, the determined archetype from a plurality of archetypes to the user.

34. The computer program product according to claim 31, wherein the operations further comprise associating the at least one descriptor with the content, wherein the at least one descriptor identifies content.

35. The computer program product according to claim 31, wherein the filtering further comprises
comparing the at least one attribute of the determined archetype with the at least one descriptor of the content; and
determining, based on the comparing, whether the at least one attribute of the determined archetype matches the at least one descriptor of the content.

36. The computer program product according to claim 35, wherein the providing further comprises
providing the filtered content to the user based on the determination that the at least one attribute of the determined archetype matches the at least one descriptor of the content.

37. The computer program product according to claim 31, wherein the operations further comprise
determining another archetype of the user, wherein at least another attribute is associated with the another determined archetype; and
ranking the determined archetype and the another determined archetype.

38. The computer program product according to claim 37, wherein the providing further comprises
providing the filtered content in a ranking order based on the ranking of the determined archetype and the another determined archetype.

39. The computer program product according to claim 31, wherein the operations further comprise:
receiving a request to modify the determined archetype assigned to the user; and
modifying, based on the receiving, the determined archetype assigned to the user.

40. The computer program product according to claim 31, wherein the operations further comprise:
re-filtering the filtered content based on at least one archetype different from the determined archetype; and
providing the re-filtered content to the user.

41. The computer program product according to claim 31, wherein the operations further comprise:
sorting the filtered content based on at least one criteria; and
providing the sorted content to the user.

42. The computer program product according to claim 31, wherein the operations further comprise:
identifying a group of first contents having at least one relationship to each other;
determining a second content related to the group of first contents; and
providing the second content to the user.

43. The computer program product according to claim 42, wherein the operations further comprise:
modifying the identified group of first contents by modifying at least one first content in the identified group of first contents;
determining a third content based on the modified group of first contents; and
providing the third content to the user.

44. The computer program product according to claim 43, wherein the group of first contents is identified based on the determined archetype of the user.

45. The computer program product according to claim 31, wherein the filtering further comprises filtering the content based on a previous content provided to the user.
